(19) United States
(12) Patent Application Publication
(10) Pub. No.: US 2008/0205860 A1
(43) Pub. Date: Aug. 28, 2008

(54) Method Of Live Submitting A Digital Signal

(75) Inventor: Koen Johanna Guillaume Holtman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/816,306

(22) PCT Filed: Feb. 14, 2006
(86) PCT No.: PCT/IB06/50481

§ 371 Date: Aug. 15, 2007

(30) Foreign Application Priority Data
Feb. 18, 2005 (EP) 05101266.4
Nov. 17, 2005 (EP) 05110890.0

(51) Int. Cl. H04N 5/00

(52) U.S. Cl. 386/125; 386/E05.001

(57) ABSTRACT

A method of generating in real-time an audio-video transport stream from a sequence of audio-video data fragments, the audio-video data fragments from the sequence having a variable bit length and a predetermined presentation time length, the method comprising steps of generating or receiving in real time the audio-video data fragments; generating the audio-video transport stream by assembling together the audio-video data fragments in the order they are generated or received; inserting padding data between subsequent parts of the audio-video transport stream corresponding to subsequent audio-video data fragments, the amount of the padding data between the subsequent parts being chosen such that a distance between locations of a start of the subsequent parts of the audio-video transport stream corresponds to a predetermined bit length.

### FIELD OF THE INVENTION

This application relates to a method of generating in real-time an audio-video transport stream from a sequence of audio-video data fragments, a method of generating metadata associated with said audio-video transport stream, use of said methods in a game engine, a method of submitting a digital signal in real time by means of a data stream, a method of playback in real time of a received digital signal. The application also relates to an apparatus for generating an audio-video transport stream in real time, an apparatus for generating metadata associated with said audio-video transport stream, a broadcasting system for submitting a digital signal and a playback system for receiving and playing back a digital signal.

### BACKGROUND OF THE INVENTION

New forms of consumer electronics are continually being developed. Many efforts have been focused on the convergence of Internet and home entertainment systems. Important areas are interactivity and enhanced functionality, by merging broadcasted audio-video content with locally available audio-video content. Several industry discussion forums in the area of Digital Video Broadcast (DVB) like the European MHP (Multimedia Home Platform) or the US Dase Platform disclose the use of Internet resources to enhance functionality.

For example, it is envisioned that next generation optical disc players/recorder, for example such as Blu-ray players/recorder, will have the functionality that audio and video data can be streamed from a studio web server, to be displayed on the TV by the BD-ROM player. This streaming happens by dividing the video data into many small files on the server, and then downloading these files individually via HTTP requests. After being played, these small files optionally can be deleted again. Said streaming method is also known in the art as ‘progressive playlist’.

Data Structures:

A preferred encoding method for encoding audio-video content is variable rate encoding, as it allows higher levels of compression for a given encoding quality level. Consequently, in order to allow trick-play, metadata with respect to the video and audio information is stored on optical disc in addition to the audio-video content. For example, in the case of Blu-ray read-only optical disc (BD-ROM) metadata about the video multiplex is stored in separate files on the disc. Most important is that metadata corresponding to the characteristic point information is stored is separate files known as clip files. The characteristic point information comprises a mapping between points on the time axis for playback and offsets in the transport stream file. The characteristic point information is used to support trick-play modes, and cases where playback has to start from a particular point on the time axis. For transport stream files video data, the characteristic point information mapping usually contains one entry for each I-frame. For transport streams with audio data only, the mapping usually contains entries at regular intervals. For complete playback of the video, the ‘playback engine’ needs three levels of files: playlist, clip and transport stream.

More information about the data structures as envisioned for Blu-ray application can be found in the following white papers: “Blu-ray Disc Format: 2a-logical and audio visual format specifications for BD-RE” and “Blu-ray Disc Format: 2b-logical and audio visual format specifications for BD-ROM”, to be inserted herein by reference. The white paper on the recordable format (BD_RE) contains detailed information about the structure and the contents of the clip information files, which is also applicable to the BD-ROM format.

Data Structures and Playlists

In FIG. 1, said three levels of files that are required for playback are illustrated, for example, corresponding to the case of a movie trailer that should be streamed with the ‘progressive playlist’ method. There is one playlist file on the top row, corresponding to the full movie trailer, describing many small parts. In the middle row are clip files comprising metadata used for playback of each small part, at the bottom there are transport stream files for each small part.

To ease the player implementation, it is necessary that the playlist and clip files are ALL made available to the playback mechanism before playback is started. These files are small anyway, so downloading them all does not delay the start of playback too much. However, there is a problem in the case of live streaming, because:

a) the clip files have to comprise pointers to exact byte positions inside the transport stream files; while
b) the higher-number transport stream (mt2s) files are not available yet, because they still have to be recorded.

In other words, the problem is how to align the pointers in the clip files, which have to be available from the start, with the data in the transport stream files, which is not available yet because they still have to be recorded.

### SUMMARY OF THE INVENTION

It is an object of the invention to provide a solution to the above-mentioned problem. This object is achieved by generating in real-time an audio-video transport stream characterized as recited in claim 1. The term ‘real-time’ is used somewhat loosely in the art. With respect to this invention, we define ‘real-time’ as a time period, which starts after the point in time at which both presentation time lengths and bit lengths, as described below, have been pre-determined.

An audio-video transport stream is generated in real time by assembling together a sequence of audio-video data fragments of variable bit length and predetermined presentation time length in the order said fragments are generated or received. The generation is performed such that parts of the audio-video transport stream (i.e. a transport stream containing either audio, or video, or both) corresponding to subsequent audio-video data fragments are separated by padding data. The amount of the padding data between subsequent parts is chosen such that a distance between locations of a start of the subsequent parts corresponds to a predetermined bit length. Adding padding data as described hereinabove leads to an audio-video transport stream comprising a sequence of parts of predetermined presentation time lengths and predetermined bit lengths. The presence of parts of predetermined presentation time lengths and predetermine bit length in an audio-video transport stream according to the invention carries the advantage that the associated metadata required for playback is predictable and can be computed and made available to the playback mechanism in the player before all the audio-video data fragments are made available. Consequently, if such associated metadata is computed and made available to the player, real-time playback of ‘live’ audio-video content, i.e. content containing data bits that were created during the real-time period, is made possible.

In an advantageous embodiment, the predetermined bit length is constant, i.e. the same for all fragments, the value of the constant being chosen such that it is larger than a maximum expected bit length of a audio-video data fragments. The audio-video data fragments can advantageously have a constant predetermined presentation time length; therefore the expected maximum bit length can be predicted based on the used compression parameters. One has to ensure that the amount of padding data required to reach the predetermined bit length of a part is positive. If there is at least one audio-video data fragment whose bit length exceeds the predetermined bit length, the associated metadata cannot be generated before the full sequence of audio-video fragments is generated or received.

In an advantageous embodiment, the audio-video transport stream is generated by further assembling audio-video data from a second audio-video transport stream together with the received or generated audio-video data fragments. Preferably, in the case of video multiplexing, the filler data takes the form of null packets.

The invention also relates to a method of generating metadata associated with an audio-video transport stream that can be generated from a sequence of audio-video data fragments, the generation of the audio-video transport stream taking place according to inventive method described hereinabove. The method is characterized by the metadata comprising at least information about the location of a beginning and about a presentation time of a part of the audio-video transport stream corresponding to an audio-video data fragment, and the metadata being generated before at least one of the audio-video data fragments is generated or received. Such a method of generating metadata carries the advantage that the metadata can be made available to a playback device before all the audio-video data fragments is generated or received, therefore enabling real time streaming.

The invention also relates to a method of submitting a digital signal in real time by means of a data stream, the data stream comprising an audio-video transport stream being generated from a sequence of audio-video data fragments according to the corresponding inventive method described hereinabove and associated metadata being generated according to the corresponding inventive method described hereinabove.

The invention also relates to a method of submitting a digital signal in real time by means of a data stream, the data stream comprising a sequence of audio-video data fragments being generated according to the corresponding inventive method described hereinabove and associated metadata being generated according to the corresponding inventive method described hereinabove.

The invention also relates to a digital signal either comprising an audio-video transport stream generated according to the corresponding inventive method describe hereinabove or comprising metadata associated to an audio-video transport stream, the metadata generation taking place according to the corresponding inventive method describe hereinabove.

The invention also relates to the use in a game engine of the method of generating in real-time an audio-video transport stream according to claim 1 or of the method of generating metadata associated with an audio-video transport stream according to claim 5. With a game engine, we mean a system that does not generate audio-video content by recording something in the real world, but that generates audio-video content by computational means, to represent a simulated or virtual reality, e.g. a reality inside a game.

The invention also relates to an apparatus for generating an audio-video transport stream according to claim 16.

The invention also relates to an apparatus for generating metadata associated with a sequence of audio-video data fragments.

The invention also relates to a broadcasting apparatus comprising an apparatus according to the invention for generating an audio-video stream.

The invention also relates to a broadcasting apparatus comprising an apparatus according to the invention for generating metadata associated with a sequence of audio-video data fragments.

The invention also relates to a playback apparatus for receiving and playing back a digital signal according to the invention.

### BRIEF DESCRIPTION OF THE DRAWINGS

The features and advantages of the invention will be appreciated upon reference to the following drawings, in which:

FIG. 1 illustrates schematically the three levels of files: playlist, clip, and transport stream required by a playback apparatus in order to be able to playback an audio video transport stream;

FIG. 2 illustrates schematically method of generating an audio-video transport stream and a method of generating metadata associated with said audio-video transport stream according to an embodiment of the invention;

FIG. 3 illustrates schematically a transmission system comprising a broadcasting apparatus and a playback apparatus according to an embodiment of the invention;

FIG. 4 illustrates schematically a broadcasting apparatus according to an embodiment of the invention;

FIG. 5 illustrates schematically a playback apparatus according to an embodiment of the invention.

### DETAILED DESCRIPTION OF THE PREFERRED EMBODIMENTS

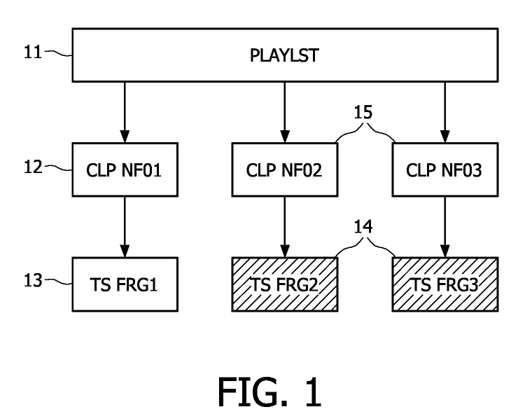

In FIG. 1 the three levels of files required by a playback apparatus in order to be able to playback an audio-video transport stream are illustrated. For example this may correspond to a movie trailer that should be streamed according to the ‘progressive playlist’ method. There is one playlist file 11 on the top row, in the above-mentioned example corresponding to the full movie trailer to be streamed, the playlist file 11 describing many small items. Associated with this playlist file 11, clip files 12, 15 corresponding to each small item are illustrated in the middle row.

At the third level, to each clip file 12, 15, a corresponding transport stream file 13, 14 is associated. In the case of live streaming; the hashed transport stream files 14 are not yet available to the playback apparatus, i.e. they have not yet been received and/or generated). The problem is that the playback apparatus requires that the clip files 15 associated with these non-available transport stream files 14 to be available before the playback is started.

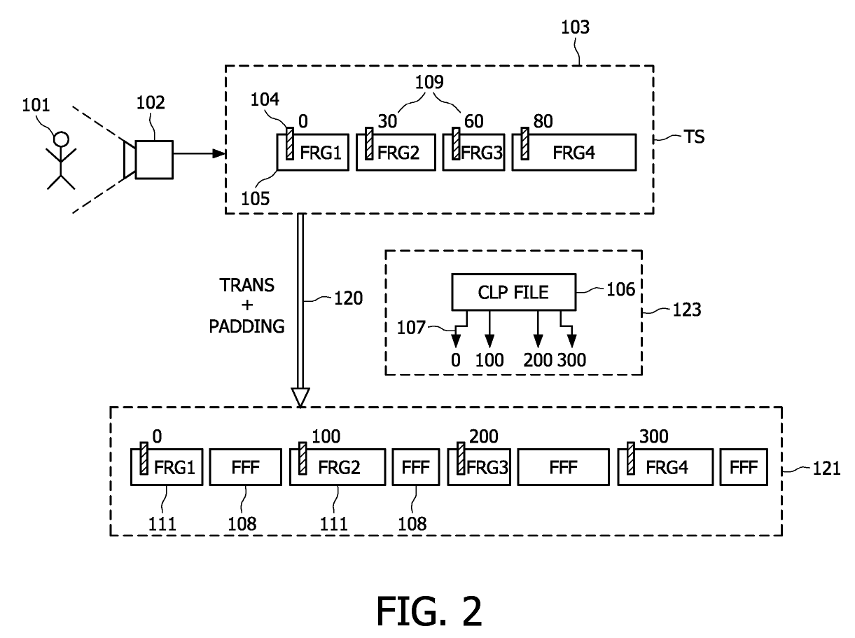

FIG. 2 illustrates schematically method of generating an audio-video transport stream and a method of generating metadata associated with said audio-video transport stream according to an embodiment of the invention that overcome the above-mentioned problem.

For example, a camera 102 makes a live recording of a director 101 commenting a movie. The recording takes the form of a transport stream 103 comprising a sequence of audio-video data fragments of unequal bit lengths but of equal presentation time lengths. For example, a single fragment 105 comprises a corresponding characteristic point 104. Because of the unequal sizes of the fragments 105, these characteristic points 104 appear in the transport stream 103 at unequal offsets 109, in the example illustrate in FIG. 2, the offsets being 0, 30, 60, 80. The clip file 106 corresponding to a fragment 105 needs to comprise information about these characteristic points, that is it should comprise the list of all offsets. Such list of offsets associated with the transport stream 103 cannot be generated before the full transport stream 103 is available. In contrast, in a method of generating associated metadata according to the invention, pointers 107 are added in the clip file 106 at widely spaced playback offsets 110. In a method of generating an audio-video transport stream 121 according to the invention, padding data 108 is inserted between the individual fragments 111 in the generated audio video transport stream 121. Before the audio video transport stream 121 is supplied to the playback engine, it is ensured that the playback offsets 110 in said transport stream 121 match corresponding pointers 107 in the clip file 106. Therefore metadata associated with a transport stream 121 according to the invention can be predicted and generated in advance before the actual data fragments are generated. Consequently the associated metadata can be downloaded before the beginning the process of playback of video, as required by the player.

| | Presentation Times (PTS) | Source packet number |
|---|---|---|
| | sequence (seconds) | (SPN) |
| Known TS (103) | 0 s, 0.5 s, 1 s, 1.5 s . . . | 0, 30, 60, 80 . . . |
| Inventive TS (121) | 0 s, 0.5 s, 1 s, 1.5 s . . . | 0, 100, 200, 300 . . . |

For example, in the case of Blu-ray disc (BD) media and players, the clip info files comprise information with respect to the presentation times (PTS) and file positions (SPN, source packet number) of I-frames. In practice, pre-determined spacing between fragments should be larger than shown in table 1 above, to handle worst-case group of picture (GOP) length for the recording. Moreover, besides creating fixed I-frame locations, padding might also be used to get fixed locations for some other SPN references in clip info file. If the streamed data is to be kept for a long time on local storage, then padding data can be removed to save space. In that case, new clip (CPI) info files, containing SPN locations of un-padded TS files, may be used.

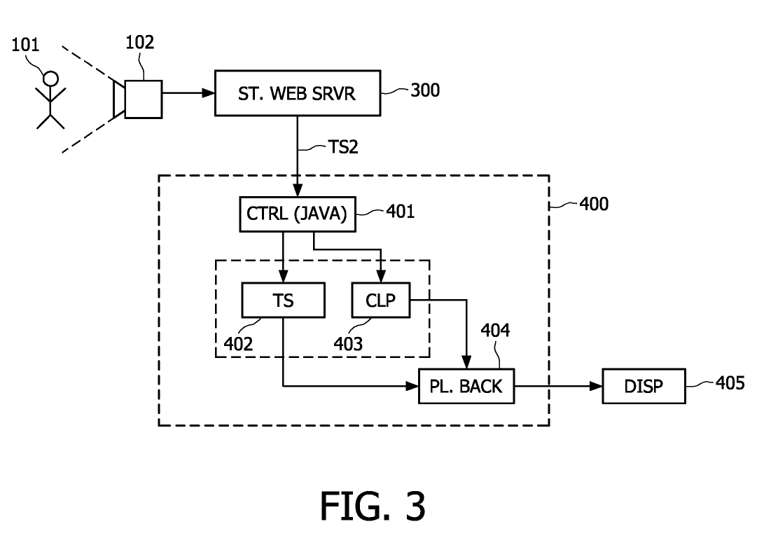

FIG. 3 illustrates schematically a transmission system comprising a broadcasting apparatus and a playback apparatus according to an embodiment of the invention; Further references will be made to the audio transport stream 121 according to the invention and the associated metadata 106 according to the invention, as disclosed with respect to FIG. 2.

For example a recording that is made live by a camera 102 is made available in real time as a transport stream (TS2) by a broadcasting apparatus, for example a studio web server 300. The transport stream TS2 is received or downloaded by a playback apparatus 400, for example a Blu-Ray disc (BD) player. Usually a control layer (401), in the case of Blu-Ray disc (BD) player a Java program running on a Java Virtual Machine, is controlling the download of the transport stream TS2.

Preferably, though not essentially, the transfer of the recorded data 103 is done before the padding data 108 is added. The padding data 108 is preferably added on the player 400 side, by the Java program 401 that controls the downloading process. This Java program 401 therefore needs to have:

1) the recorded data, i.e. the sequence of audio video fragments 103 (which may be retrieved over the network, preferably in the form of files requested via HTTP);
2) additional instructions that specify how filler data should be added to the recorded data, in order to produce transport stream files that are aligned with the clip files.

These additional instructions could be:

a) sent over the network (in which case it preferably takes the form of a list of offsets and lengths), as illustrated in FIG. 2 or in table 1;
b) might also be stored on the disc, or be encoded in the Java program itself. In this latter case, the data preferably takes the form of instructions of how to parse (recognize certain markers) the downloaded recorded data, and how to act when encountering certain markers.

Another, less preferred solution is that the padding data is added at the studio web server side, after which the file is compressed, before being transferred over the network. The file is then decompressed in the player after it was received.

The locally generated or the downloaded clip file is stored in a storage space 403 (either memory or on disc).

Note that, although the figures and the text of the application focus on live streaming of audio/video data, in other cases just an audio track could be streamed live, without any video. A special example of this latter case is a live event where the director speaks audio commentary while controlling the playback of the movie that is stored on the disc in the BD-ROM player. That way, the director can respond to questions by showing a part of the movie, while speaking in a voice-over.

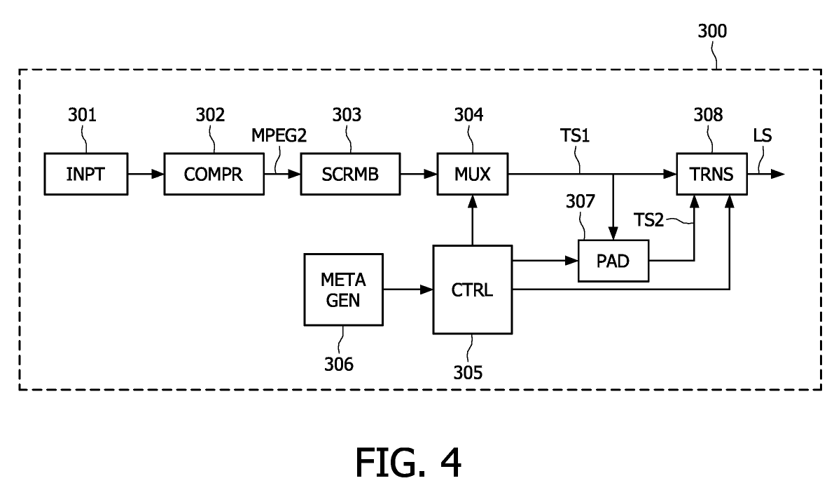

FIG. 4 illustrates schematically a broadcasting apparatus according to an embodiment of the invention;

Input means (301) receive the audio-video content to be streamed. A compressor (302) compresses the audio-video content into an MPEG2 stream (MPEG2). The compression preferably comprises variable bit compression rate. Optionally, a scrambler (303) may scramble the MPEG2 stream by encrypting it under the control of a content key, and then it delivers the MPEG2 stream to a multiplexer (304). In addition to the MPEG2 stream, the multiplexer (104) may also receive one or more scrambled or non-scrambled data streams (DS) and further digital signals from a controller (305). The multiplexer (304) assembles by time-multiplexing the scrambled or unscrambled MPEG2 stream and the one or more data streams (DS) into a transport stream (TS1) comprising a sequence of audio-data fragments of fixed presentation time length and variable bit length. The scrambling and multiplexing may be performed in separate units, and if desired, at different locations. As such a transport stream (TS1) comprises one or more types of streams, also known to the person skilled in the art under the name services, each service comprising one or more service components. A service component is also known as a mono-media element. Examples of service components are a video elementary stream, an audio elementary stream, a subtitle component, a Java application (Xlet) or other data type. A transport stream is formed by time multiplexing one or more elementary streams and/or data.

A broadcasting apparatus according to the invention may comprise padding means (307) for adding padding data to the transport stream (TS1) and generating a padded transport stream (TS2) according to one of corresponding methods described with reference to FIGS. 2 and 3. Such padding means (307) may be implemented as a separate hardware unit or preferably may be integrated in the controller (305) by means of suitable firmware. The broadcasting apparatus according to the invention may further comprise a metadata generating means (306) for generating associated metadata according to one of corresponding methods described with reference to FIGS. 2 and 3. Such metadata generating means (306) may be implemented as a separate hardware unit or preferably may be integrated in the controller (305) by means of suitable firmware. The generated metadata is either provided by the controller 305 to the multiplexer 304 to be inserted in as a component of either of the two streams or directly supplied in form of a separate file to a transmitter (308).

The transmitter (308), which, for example, may be a web server, generates the live signal (LS) to be distributed. Depending on the specific embodiment, the transmitter (308) may receive either the audio video stream (TS1) comprising the sequence of audio data fragment (the preferred embodiment) or the padded audio video stream (TS2). The transmitter may also receive the associated metadata from the controller 305.

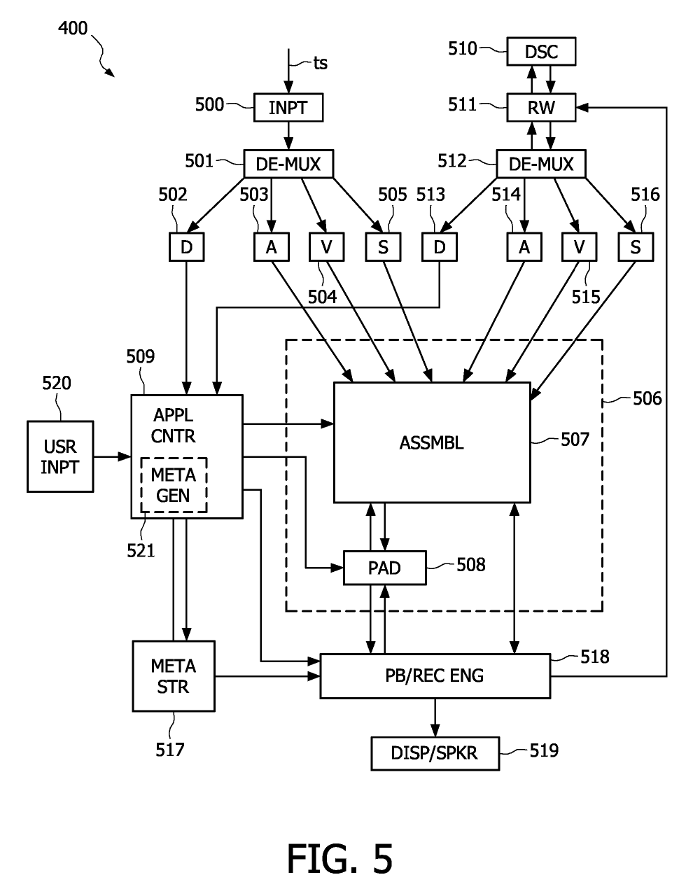

FIG. 5 illustrates schematically a playback apparatus according to an embodiment of the invention;

Typical examples of playback apparatuses 400, where the invention may be practiced, comprise set-top-boxes (STB), digital television units equipped with Digital versatile Disc (DVD) and/or Blu-ray Disc (BD) playback abilities, or computer based entertainment systems, also known under the name Home Media Servers. While not necessary for practicing our invention, the playback apparatus 400 may comply with a defined open platform like the European MHP (Multimedia Home Platform) or the US Dase Platform. These public platforms define several types of applications that may be recognized and executed by the end user system. For example, the European MHP platform specifies that applications may be included as Java™ applications. Such applications are also known to the person skilled in the art under the name Xlets.

A demultiplexer 501 splices the received live signal (LS) into a data stream 502 and audio 503, video 504, and subtitle 505 streams. The audio, video and subtitle streams (503,504,505) are fed to a controller 506, which via a specific operating system controls all the software and hardware modules of the playback apparatus 400. The audio/video content may also be passed through a conditional access sub-system (not shown in FIG. 5), which determines access grants and may decrypt data. The controller 506 provides the audio 503 and video 504 and subtitle 505 streams to a playback/recording engine 518 that converts them into signals appropriate for the video and audio 519 rendering devices (for example display and speakers, respectively).

The functioning of the playback apparatus is under the control of a general application controller 509. For example, in the case of BD players, this corresponds to an abstraction layer, known in the art under name the Application Manager, being present between any application to be executed by the playback apparatus and the specific system resources of the playback apparatus. The data stream 502 outputted by the demultiplexer 501 is fed to the Application Manager 509. Any application comprised in the data stream 502 will be executed by the Application Manager 509.

As discussed above with respect to the broadcasting apparatus 300, the data stream comprised in the received live signal according to the invention should comprise either associated metadata or instructions how to generate the associated metadata. Consequently the Application Manager 509 may comprise means 521 for generating metadata. The Application Manager 509 may generate or transmit the metadata, for example in the form of clip files, to metadata storage means 517, which may correspond to a memory or a suitable storage media.

The controller 506 may further comprise assembling means 507 for receiving several audio, video and subtitle streams and assembling them into an audio video transport stream. Padding means 508 ensure adding padding data according to the invention, as disclosed with reference to FIGS. 2 and 3. Such assembling means 507 and/or padding means 508 may be implemented as a separate hardware unit or preferably may be integrated in the controller 506 by means of suitable firmware. The assembling means 507 and the padding means 508 may be controlled by the Application manager 509.

The playback apparatus comprises means 511 for reading and/or writing from/onto a record carrier 510. Such reading and/or writing means 511 are known in the art and will not be detailed further. The apparatus may comprise demultiplexer 512 for de-multiplexing audio-video content that is read from the record carrier 510. Although shown as different blocks in FIG. 5, the two demultiplexer 501 and 512 for de-multiplexing the live stream (LS) and the audio-video content that is read from the record carrier 510 may be embodied by a single demultiplexer able to handle multiple input streams.

The assembling means 507 may assemble the received streams (503, 504, 506) or parts thereof with the stream (514,515,516) read from the record carrier 510 or parts thereof. This happens, for example, in the previously discussed example of a live event where the director speaks audio commentary while controlling the playback of the movie that is stored on the record carrier.

### Additional Considerations

The methods described here are not restricted to MPEG-2 files, but are also applicable to files made with other codecs. It can also be applied to audio files (e.g. in the case of pre-recorded video from a disc is mixed with streamed audio files). Also, the methods are not restricted to transport streams; they can also be used for systems with program streams or other audio-video data packing methods.

It is noted that the above-mentioned embodiments are meant to illustrate rather than limit the invention. And those skilled in the art will be able to design many alternative embodiments without departing from the scope of the appended claims. In the claims, any reference signs placed between parentheses shall not be construed as limiting the claim. Use of the verbs “comprise” and “include” and their conjugations do not exclude the presence of elements or steps other than those stated in a claim. The article “a” or an” preceding an element does not exclude the presence of a plurality of such elements. The invention may be implemented by means of hardware comprising several distinct elements and/or by means of a suitable firmware. In a system/device/apparatus claim enumerating several means, several of these means may be embodied by one and the same item of hardware or software. The mere fact that certain measures are recited in mutually different dependent claims does not indicate that a combination of these measures cannot be used to advantage.

1. A method of generating in real-time an audio-video transport stream from a sequence of audio-video data fragments, the audio-video data fragments from the sequence having a variable bit length and a predetermined presentation time length, the method comprising steps of:
generating or receiving in real time the audio-video data fragments;
generating the audio-video transport stream by assembling together the audio-video data fragments in the order they are generated or received;
the method characterized by:
inserting padding data between subsequent parts of the audio-video transport stream corresponding to subsequent audio-video data fragments, the amount of the padding data between the subsequent parts being chosen such that a distance between locations of a start of the subsequent parts of the audio-video transport stream corresponds to a predetermined bit length.

2. A method of generating in real-time an audio-video transport stream according to claim 1, characterized by choosing a constant value for the predetermined bit length that is larger than the maximum expected bit length of an audio-video data fragment.

3. A method of generating in real-time an audio-video transport stream according to claim 1, characterized by the audio-video transport stream being generated by further assembling audio-video data from a second audio-video transport stream together with the received or generated audio-video data fragments.

4. A method of generating in real-time an audio-video transport stream according to claim 3, characterized by the audio-video fragments comprising audio data corresponding to video data in the second audio-video transport stream.

5. A method of generating in real-time an audio-video transport stream according to claim 1, characterized by padding data being null packets.

6. A method of generating metadata associated with an audio-video transport stream that can be generated from a sequence of audio-video data fragments that is received or generated in real time, the audio-video data fragments having a variable bit length and a predetermined presentation time length, the generation of the audio-video transport stream being performed according to method of claim 1, the method comprising steps of
generating metadata comprising information about an expected location of a start and about an expected presentation time of a part of the audio-video transport stream associated with an audio-video data fragment from the sequence;
the method characterized by generating the metadata before at least one of the audio-video data fragments is generated or received.

7. A method of submitting a digital signal in real time by means of a data stream, the method comprising steps of:
generating in real time a sequence of audio-video data fragments, the audio-video data fragments having a variable bit length and a predetermined presentation time length;
generating in real time an audio-video transport stream from the sequence of audio-video data fragments, the generation of the audio-video transport stream being performed according to the method of claim 1;
generating metadata associated with the audio-video transport stream that can be generated from a sequence of audio-video data fragments that is received or generated, in real time, the audio-video data fragments having a variable bit length and a predetermined presentation time length, the generation of the audio-video transport stream being performed according to method of claim 1, the method comprising steps of
generating metadata comprising information about an expected location of a start and about an expected presentation time of a part of the audio-video transport stream associated with an audio-video data fragment from the sequence;
the method characterized by generating the metadata before at least one of the audio-video data fragments is generated or received;
submitting the associated metadata before submitting at least part of the generated audio-video transport stream;
submitting in real time the audio-video transport stream.

8. A method of submitting a digital signal in real time by means of a data stream, the method comprising steps of:
generating in real time a sequence of audio-video data fragments, the audio-video data fragments having a variable bit length and a predetermined presentation time length;
generating in real-time an audio-video transport stream from a sequence of audio-video data fragments, the audio-video data fragments from the sequence having a variable bit length and a predetermined presentation time length, the method comprising steps of:
generating or receiving in real time the audio-video data fragments,
generating the audio-video transport stream by assembling together the audio-video data fragments in the order they are generated or received,
the method characterized by:
inserting padding data between subsequent parts of the audio-video transport stream corresponding to subsequent audio-video data fragments, the amount of the padding data between the subsequent parts being chosen such that a distance between locations of a start of the subsequent parts of the audio-video transport stream corresponds to a predetermined bit length;
generating metadata associated with the audio-video transport stream, the metadata generation being performed according to method of claim 6;
submitting the metadata prior to the generation of at least one of audio-video data fragments;
submitting in real time the sequence of audio-video data fragments in the order of generation.

9. A method of submitting a digital signal according to claim 8, characterized by further submitting information for generating the audio-video transport stream comprising at least information about the predetermined bit length.

10. A method of submitting a digital signal according to claim 8, characterized by further including markers within the audio-video data fragments.

11. A method of playback in real time of a received digital signal, the digital signal being submitted according to the method of claim 7, the method comprising steps of:
receiving the generated metadata;
receiving in real time the audio-video transport stream;
playing back parts of the audio-video transport stream corresponding to the audio-video data fragments.

12. A method of playback in real time of a received digital signal, the digital signal being submitted according to the method of claim 8, the method comprising steps of:
receiving the generated metadata;
receiving in real time the sequence of audio-video data fragments;
generating an audio-video transport stream from the sequence of audio-video data fragments, the audio-video data fragments from the sequence having a variable bit length and a predetermined presentation time length, generating step comprising steps of:
generating or receiving in real time the audio-video data fragments;
generating the audio-video transport stream by assembling together the audio-video data fragments in the order they are generated or received;
the method characterized by:
inserting padding data between subsequent parts of the audio-video transport stream corresponding to subsequent audio-video data fragments, the amount of the padding data between the subsequent parts being chosen such that a distance between locations of a start of the subsequent soft audio-video transport stream corresponds to a predetermined bit length;
playing back parts of the audio-video transport stream corresponding to the audio-video data fragments.

13. Use in a game engine of a method of generating in real-time an audio-video transport stream from a sequence of audio-video data fragments, the audio-video data fragments from the sequence having a variable bit length and a predetermined presentation time length, the method comprising steps of:
generating or receiving in real time the audio-video data fragments;
generating the audio-video transport stream by assembling together the audio-video data fragments in the order they are generated or received;
the method characterized by:
inserting padding data between subsequent parts of the audio-video transport stream corresponding to subsequent audio-video data fragments, the amount of the padding data between the subsequent parts being chosen such that a distance between locations of a start of the subsequent parts of the audio-video transport stream corresponds to a predetermined bit length, or of a method of generating metadata associated with an audio-video transport stream according to claim 5.

14. A digital signal comprising an audio-video transport stream, the digital signal characterized by the audio-video transport stream being generated by a method according to claim 1 from a sequence of audio-video data fragments, the audio-video data fragments having a variable bit length and a predetermined presentation time length.

15. A digital signal comprising a sequence of audio-video data fragments, the audio-video data fragments having a variable bit length and a predetermined presentation time length;
the digital signal characterized by further comprising metadata associated with an audio-video transport stream that can be generated from said sequence, the audio-video transport stream being generated from a sequence of audio-video data fragments, the audio-video data fragments from the sequence having a variable bit length and a predetermined presentation time length, by:
generating or receiving in real time the audio-video data fragments;
generating the audio-video transport stream by assembling together the audio-video data fragments in the order they are generated or received;
the method characterized by:
inserting padding data between subsequent parts of the audio-video transport stream corresponding to subsequent audio-video data fragments, the amount of the padding data between the subsequent parts being chosen such that a distance between locations of a start of the subsequent parts of the audio-video transport stream corresponds to a predetermined bit length, the generation of the metadata being performed by a method according to claim 4.

16. An apparatus for generating an audio-video transport stream comprising:
input means for receiving or generating in real time a sequence of audio-video data fragments, the audio-video data fragments having a variable bit length and a predetermined presentation time length;
assembling means for assembling an audio-video transport stream from the sequence of audio-video data fragments in the order they are generated/received;
characterized in that the apparatus further comprises:
padding means for adding padding data subsequent parts of the audio-video transport stream corresponding to subsequent audio-video data fragment;
control means for enabling the padding means to add an amount of the padding data between subsequent parts of the audio-video transport stream corresponding to subsequent audio-video data fragment such that a distance between locations of a start of the subsequent parts of the audio-video transport stream corresponds to a predetermined bit length.

17. An apparatus according to claim 16, characterized in that the control means are further adapted to enable the padding means to add padding data such that the predetermined bit length has a constant value larger than the maximum expected bit length of an audio-video data fragment.

18. An apparatus according to claim 16, characterized in that the padding means are adapted to add padding data in the form of null packets.

19. An apparatus according to claim 16, characterized in that the apparatus further comprises:
second input means for receiving or generating in real time a second audio-video transport stream;
the assembling means being further adapted to assemble the second audio-video transport stream together with the received or generated audio-video data fragments into the audio-video transport stream.

20. An apparatus for generating metadata associated with a sequence of audio-video data fragments, the audio-video data fragments having a predetermined presentation time length and a variable bit length, the apparatus comprising:
input means for receiving or generating in real time the sequence of audio-video data fragments;
the apparatus characterized in that it further comprises:
metadata generation means for generating metadata associated to an audio-video transport stream that can be generated by adding padding data between subsequent parts of the audio-video transport stream corresponding to subsequent audio-video data fragments, the amount padding data being chosen such that the distance between locations of a start of subsequent parts corresponds to the predetermined bit length;
the control means adapted to enable the metadata generation means to generate the metadata before at least one of the audio-video data fragments is generated or received.

21. A broadcasting apparatus for submitting a digital signal, the broadcasting apparatus comprising an apparatus for generating an audio-video transport stream according to claim 16;
the broadcasting apparatus further comprising transmission means for generating a digital signal comprising the generated audio-video stream.

22. A broadcasting apparatus for submitting a digital signal, the broadcasting system comprising an apparatus for generating an metadata associated with an audio-video transport stream according to claim 20;
the broadcasting apparatus further comprising:
transmission means transmission means for generating a digital signal comprising the sequence of audio-video fragments and the associated metadata.

23. A playback apparatus for receiving and playing back in real time a digital signal, the playback apparatus comprising:
input means for receiving in real time a digital signal submitted by a broadcasting apparatus according to claim 22;
demultiplexing means for separating the associated metadata and the sequence of audio-video fragments;
assembling means for assembling an audio-video transport stream from the sequence of audio-video data fragments in the order they are generated/received;
characterized in that the apparatus further comprises:
padding means for adding padding data between subsequent parts of the audio-video transport stream corresponding to subsequent audio-video data fragments;
control means for enabling the padding means to add an amount of the padding data between the subsequent parts of the audio-video transport stream such that a distance between locations of a start of the subsequent parts corresponds to the predetermined bit length;
playback means for receiving the audio-video stream and the associated metadata and for playback in real time of the audio-video transport stream.

24. A playback apparatus according to claim 23, characterized in that the playback apparatus further comprises:
means for reading a second audio-video transport stream from a storage medium;
the control means further adapted to enable the assembling means to assemble the second audio-video transport stream together with the received or generated audio-video data fragments into the audio-video transport stream.

25. A playback apparatus for generation and playback in real time of an audio-video transport stream generated from a sequence of audio-video data fragments stored on a storage medium, the audio-video data fragments having a variable bit length and a predetermined presentation time length;
the playback apparatus comprising:
reading means for reading the audio-video data fragments from the storage medium;
data input means for receiving information about the order or reading the audio-video data fragments;
assembling means for assembling an audio-video transport stream from the sequence of audio-video data fragments in the order they are read;
characterized in that the apparatus further comprises:
padding means for adding padding data between parts of the audio-video transport stream corresponding to subsequent audio-video data fragments;
control means for enabling the padding means to add an amount of the padding data between subsequent parts of the audio-video transport stream such that a distance between locations of a start of subsequent parts of the audio-video transport stream corresponds to the predetermined bit length;
metadata generation means for generating metadata associated to the audio-video transport stream;
playback means for receiving the audio-video transport stream and the associated metadata and for play playback in real time the audio-video stream;
the control means adapted to enable the metadata generation means to generate the metadata before at least one of the audio-video data fragments is generated or received;
